(19) United States
(12) Patent Application Publication
(10) Pub. No.: US 2006/0161334 A1
(43) Pub. Date: Jul. 20, 2006

(54) Average vehicle speed computation device and car navigation device

(75) Inventor: Yasutaka Teramae, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/317,248

(22) Filed: Dec. 27, 2005

(30) Foreign Application Priority Data
Dec. 28, 2004 (JP) 2004-380672

(51) Int. Cl. G08G 1/00

(52) U.S. Cl. 701/117; 701/1

(57) ABSTRACT

A car navigation device obtains a current position of a vehicle through a position detector, receives road traffic information through a VICS receiver. When the current position is included in congested points or congested sections of the road traffic information, a vehicle speed is not reflected on computation of an average vehicle speed even if the vehicle runs at a slow speed without stop.

### CROSS REFERENCE TO RELATED APPLICATIONS

This application is based on and incorporates herein by reference Japanese Patent Application No. 2004-380672 filed on Dec. 28, 2004.

### FIELD OF THE INVENTION

The present invention relates to an average vehicle speed computing device for computing a vehicle's average speed per hour, and a car navigation device for estimating a necessary time or an arrival time to a destination using the computed average speed.

### BACKGROUND OF THE INVENTION

For instance, a car navigation device having a route retrieval function and a route guidance function retrieves an optimum route from a current position to a destination and displays the retrieved route over a map on a display device. The car navigation device simultaneously estimates and displays an arrival time to a destination. Estimation of the arrival time first needs computation of a necessary time from the current position to the destination. The necessary time is obtained by dividing a distance from the current position to the destination by the average speed.

In Patent Document 1, an average speed is computed as follows. Each time a vehicle travels a given distance, a corresponding average speed for traveling the given distance is computed as an instantaneous speed, and an average speed is computed by using the instantaneous vehicle speed. Here, if the instantaneous vehicle speed is computed even while the vehicle stops, the computed instantaneous vehicle speed may be deviated from an actual vehicle speed. Therefore, a time period for which the vehicle stops is not included in computation of the instantaneous vehicle speed.

Patent Document 1: JP-2001-330443 A

In a congested road, a vehicle may not completely stop or slowly move. In this case, the vehicle moves at a low speed but does not stop. An instantaneous speed is computed even during this congested time period, so that an average speed is computed by using this slow instantaneous speed. Therefore, even if the vehicle thereafter gets away from the congestion, the computed average speed becomes slow due to the slow instantaneous speed in the congested road. As a result, the necessary travel time to a destination is inaccurately estimated, which poses a problem.

### SUMMARY OF THE INVENTION

It is an object of the present invention to provide an average vehicle speed computing device for solving the above problem. This device is capable of helping prevent an average vehicle speed from being computed as an extremely slow speed even when a subject vehicle travels a congested position or section. It is another object to provide a car navigation device capable of more accurately estimating a necessary travel time or an arrival time to a destination even when a subject vehicle travels a congested position or section.

To achieve the above object, an average vehicle speed computation device is provided with the following: a current position obtaining unit is included for obtaining a current position of the vehicle; a road traffic information obtaining unit is included for obtaining road traffic information including at least a congested point or a congested section; and a computation controlling unit is included for stopping computation of the average speed when the obtained current position is included within the congested point or the congested section which is obtained by the road traffic information obtaining unit.

Under this structure, when the vehicle is in a congested position or a congested road section, computation of the average speed is stopped by using the road traffic information. Therefore, even if the vehicle travels at a slow speed, a problem that the average speed is computed as an extremely slow speed can be solved.

In another aspect of the present invention to produce a similar effect of that of the above structure, an average vehicle speed computation device is provided with the following. In computing an average speed of a vehicle, an instantaneous speed is used. This instantaneous speed is obtained as an average speed with respect to a determination distance each time the vehicle travels the determination distance. Furthermore, a current position obtaining unit is included for obtaining a current position of the vehicle; a road traffic information obtaining unit is included for obtaining road traffic information including at least a congested point or a congested section; and a computation controlling unit is included for designating a weight of the instantaneous speed in computation of the average speed based on a congestion degree, when the obtained current position is included within the congested point or congested section which is obtained by the road traffic information obtaining unit. Here, when the obtained current position is included within the congested point or the congested section, a degree for using the instantaneous speed in the computation of the average speed is varied based on the weight designated by the computation controlling unit.

Moreover, to achieve the above object, a car navigation device is provided with the following. One of the average vehicle speed computation devices that are described above is included. Furthermore, a remaining distance computing unit is included for computing a remaining distance from a current position to a destination during route guidance; a necessary time computing unit is included for computing an estimated necessary time to a destination based on the computed remaining distance and the average speed computed by the average vehicle speed computation device; and a notifying unit is included for indicating at least one of (i) the computed estimated necessary time and an estimated arrival time to the destination obtained from the computed estimated necessary time.

Under the above structure of the car navigation device, the necessary travel time or the arrival time to a destination can be more accurately estimated.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram of a car navigation device according to a first embodiment of the present invention;

FIG. 2 is a flowchart diagram for computing an average vehicle speed;

FIG. 3 is a flowchart diagram for displaying an estimated necessary time and an estimated arrival time;

FIG. 4 is a table of initial values of average vehicle speeds according to road classes;

FIG. 5 is a display view showing a guidance route, an estimated necessary time, and an estimated arrival time on a map;

FIG. 6 is a flowchart diagram for computing an average vehicle speed according to a second embodiment;

FIG. 7 is a table of coefficients according to congestion degrees; and

FIG. 8 is a table of coefficients according to road classes and congestion degrees according to a third embodiment.

### DETAILED DESCRIPTION OF THE PREFERRED EMBODIMENTS

### First Embodiment

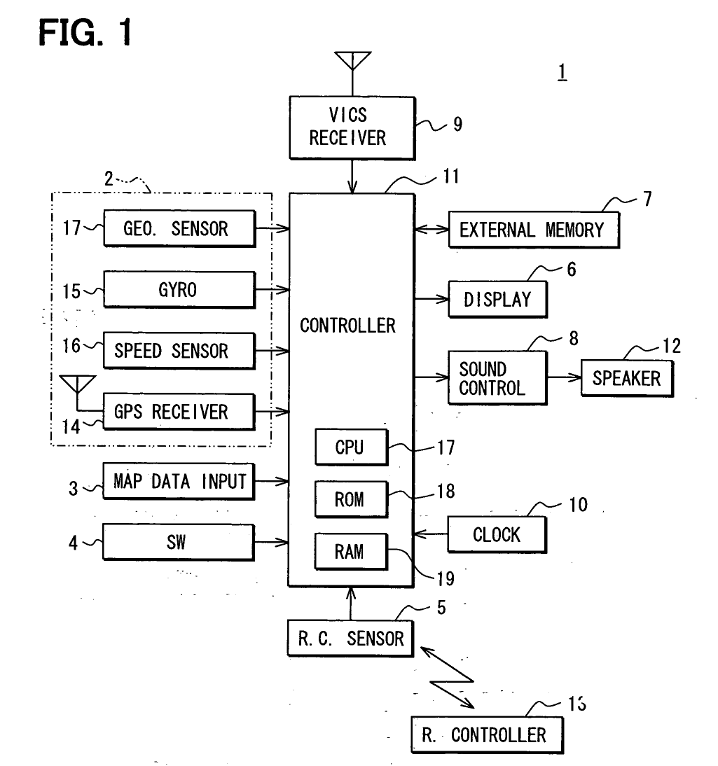

A first embodiment of the present invention will be explained below with reference to FIGS. 1 to 5. As shown in FIG. 1, a car navigation device 1 mounted in a subject vehicle includes: a position detector 2 as a current position obtaining unit for obtaining a vehicle's current position; a map data input device 3 as a map data obtaining unit; a manipulation switch group 4 as a manipulating unit; a remote controller sensor 5; a display device 6 as a display unit; an external memory 7; a sound control device 8; a VICS (Vehicle Information and Communication System) receiver 9 as a road traffic information obtaining unit for constituting a road traffic information receiver; a clock device 10 as a clocking unit; a control device 11 as a controlling unit connected with the foregoing devices or the like; a speaker 12 as a sound outputting unit 8 connected with the control device 11; and a remote controller 13 paired with the remote controller sensor 5.

The position detector 2 includes a GPS receiver 14 for detecting (measuring) a position of the vehicle based on transmission radio waves from GPS satellites; a gyroscope 15 for detecting a rotation angle speed of the vehicle; a speed sensor 16 as a speed detecting unit for detecting a travel speed (or a vehicle speed) of the vehicle; and a geomagnetic sensor 17. The control device 11 detects a current position of the vehicle based on output signals from the sensors or the like 14 to 17.

The control device 11 computes a travel distance from output signals from the speed sensor 16, and then computes a current position from (i) the computed travel distance and (ii) an advancing direction of the vehicle obtained from the gyroscope 15 and the geomagnetic sensor 17. The control device 11 further computes a current position based on radio wave signals received from the GPS receiver 14. The above sensors 14 to 17 have individual different types of errors. Therefore, the control device 11 supplements the above differently obtained two current positions with each other to compute an optimum current position.

The map data input device 3 is a CD player or a DVD player for reading data recorded on a map data storing medium such as a CD-ROM or DVD-ROM. The manipulation switch group 4 is a touch panel switch arranged on a screen of the display device 6 for a user to designate a destination or select a road map to be shown in the display device 6.

The display device 6 is, for instance, a liquid crystal display capable of full colored display. On the screen of the display device 6, road maps are displayed with their scales varied. Furthermore, pointers indicating vehicle's current positions and advancing directions are shown to overlap with the displayed road maps. The display device 6 displays input display windows for a user to input a destination or the like, and various massages or information as well. Yet furthermore, when a route guidance function for guiding a user to a destination is conducted, a route to follow (guidance route) or the like is displayed to overlap with a road map.

The VICS receiver 9 receives road traffic information sent from the VICS of an external road traffic information source to input it to the control device 11. This road traffic information includes congestion information having, with respect to congestion, a time instant of occurrence, an occurring point or road section, and a degree. The degree of congestion is indicated directly by a congestion distance or by using “high,” “middle,” or “low” substituting the congestion distance. The control device 11 detects a traffic regulation point, a congested road and its congested position (or congested point) or section, a congestion degree, or the like. The clock device 10 performs clocking operation to measure a current time instant based on clock pulses of an oscillator (not shown).

The control device 11 mainly consists of a microcomputer having a CPU 17, a ROM 18, a RAM 19, or the like for functioning as a route retrieving unit and a route guiding unit to execute functions of automatic route retrieval and route guidance based on a destination inputted by a user. In the automatic route retrieval, when a destination or a passing point is inputted by a user, an optimum route is automatically computed from a current position to the imputed destination or passing point, respectively. In the route guidance, as explained above, guidance is conducted to guide the user to the destination by overlapping the optimum route over the road map displayed on the display device 6 and further by outputting to the speaker 12 guidance voice such as “turn left at the intersection 200 m ahead” using a voice synthesis function of the sound control device 8.

When the route to the destination is retrieved by the route retrieval function or while the guidance is conducted for guiding the user along the retrieved route to the destination, the control device 11 computes an average speed of the vehicle (or an estimated average speed for the subsequent computation or estimation). The control device 11 then computes an estimated necessary time to the destination using the computed average speed and further computes an estimated arrival time to the destination using the computed necessary time and the current time instant. Therefore, the control device 11 functions as an average vehicle speed computing unit mainly constituting the average vehicle speed computation device.

The average vehicle speed is computed as follows: each time the vehicle travels a determination distance (e.g., one kilometer), the determination distance is divided by the time period necessary for traveling the determination distance to thereby obtain an instantaneous vehicle speed Va.

Then, each time the vehicle travels the determination distance and computes the instantaneous vehicle speed Va, an average vehicle speed V is computed with Formula (1):
V←V′+K(Va−V′) (1)

Here, V′ is an average vehicle speed previously computed.

Even when a route is retrieved, the average vehicle speed Va cannot be computed as long as the vehicle remains stopping at a starting or departing position. When the vehicle starts traveling and the average vehicle speed is then computed with Formula (1), an initial speed of V′ is zero. The average vehicle speed V does not thereby agree with the actual average speed of the vehicle. Therefore, an initial average vehicle speed is designated to be used as an average vehicle speed for computing a necessary time in the relevant route when the route retrieval is completed. Furthermore, this initial average vehicle speed Va is used for the first computation of an average vehicle speed V with respect to a road class of an on-travel road the vehicle is traveling. This road class will be explained below.

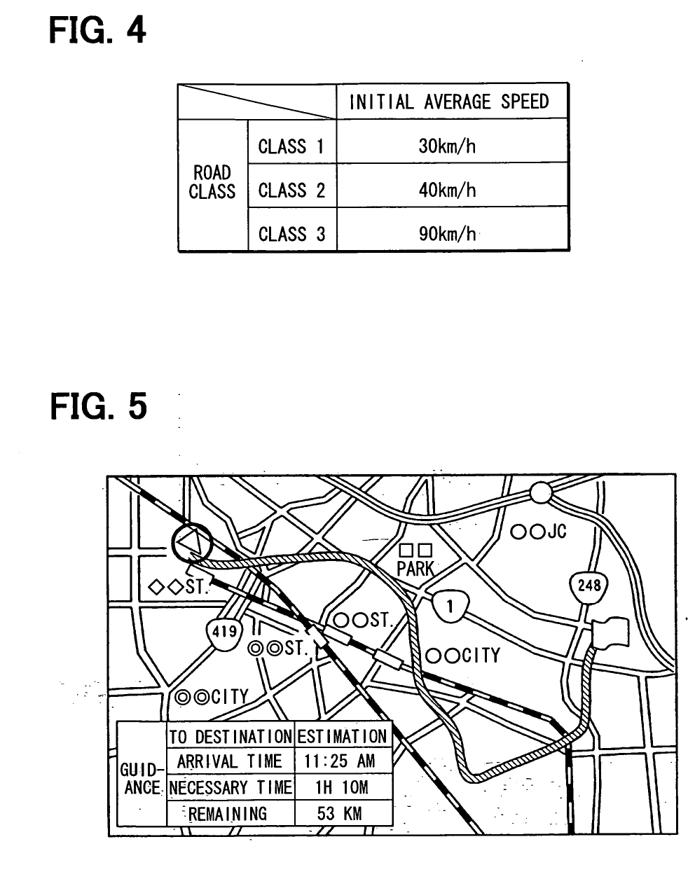

In this embodiment, roads are classified into three classes of the first class assigned to an open road in an urban area or urban road (excluding a national road), the second class to a national road and a suburban road, and the third class to an expressway and a toll road. Then, initial average vehicle speeds are previously assigned to the three classes as shown in FIG. 4 and stored on the CD-ROM or DVD-ROM of the map data storing medium. Furthermore, road kinds or classes (an urban road excluding a national road, a national road, a suburban road, an expressway, or a toll road) are previously stored in the map data.

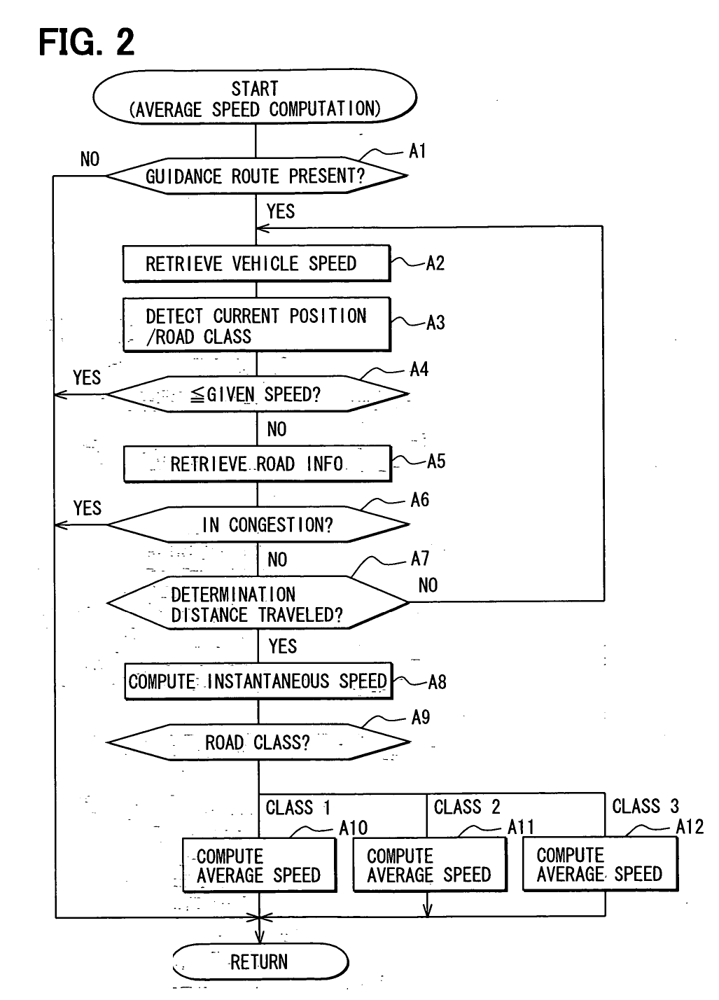

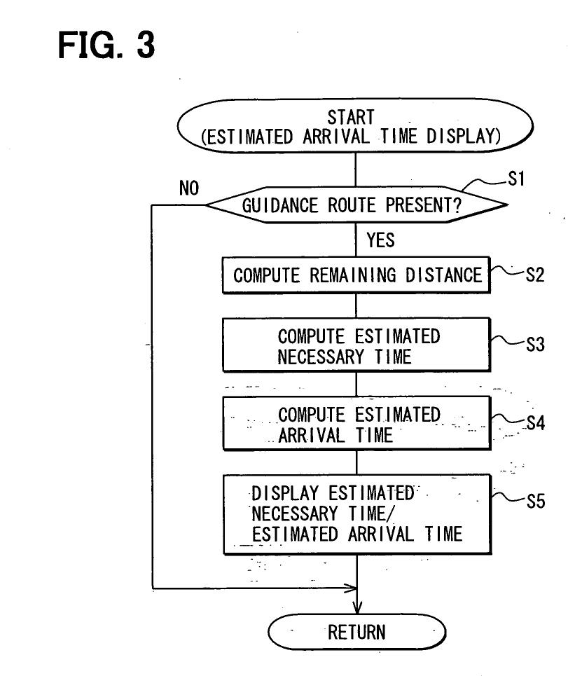

Next, operation of the control device 11 will be explained below with respect to computation of an average vehicle speed, an estimated necessary time, and an estimated arrival time, using flowcharts of FIGS. 2, 3.

The control device 11 completes a route retrieval to the inputted destination and then enters a routine for displaying an estimated necessary time and an estimated arrival time shown in FIG. 3.

At Step S1, the control device 11 determines whether a guidance route is present or not. When a guidance route is not present, the control device 11 determines “NO” at Step S1, ending the routine of FIG. 3.

When a guidance route is present (Step S1: YES), the control device 11 computes a remaining distance to the destination. This remaining distance is computed with respect to each of the above-described three road classes of the first to the third class. The control device 11 divides distances corresponding to the individual first to third road classes by the corresponding initial average vehicle speeds previously predetermined with respect to the individual road classes shown in FIG. 4, so as to obtain necessary times for traveling the individual road classes. The obtained necessary times relative to the individual road classes are totaled to compute an estimated necessary time from the current position to the destination (Step S3).

Next, the control device 11 reads a current time instant from the clock device 10 and adds the above estimated necessary time to the read current time instant to compute an estimated arrival time to the destination (Step S4). Thereafter, the control device 11 overlaps the retrieved route over the map displayed on the display device 6 shown in FIG. 5 and also displays the estimated necessary time and the estimated arrival time (Step S5). The routine shown in FIG. 3 ends.

Next, suppose that the vehicle starts from the departure point of the retrieved route and then the control device 11 enters a routine for computing an average vehicle speed shown in FIG. 2. The control device 11 first determines whether a guidance route is present or not (Step A1). When a guidance route is not present, the determination is negated and the routine ends. When a guidance route is present, the control device 11 computes a vehicle speed by retrieving a vehicle speed detection signal (Step A2), and then retrieves a road class the vehicle is currently traveling (Step A3). The road class is retrieved as follows: a current position is obtained from the position detector 2; using the current position, an on-travel road the vehicle is currently traveling is retrieved from the map data; and a road class is extracted from road data of the on-travel road.

The control device 11 then determines whether a vehicle speed is equal to or less than a given speed specified based on the road class of the on-travel road (Step A4). Here, the given speed as a determination criterion at Step A4 is specified, e.g., to 40 km/h to the third class of an expressway and a toll road, and 0 km/h to other classes. The given speed according to the road classes are previously stored in the map data storing medium such as the CD-ROM or DVD-ROM. When the current vehicle speed is equal to or less than the given speed previously specified according to the road class (Step A4: YES), the control device 11 returns the sequence without computing an average vehicle speed.

When the current vehicle speed exceeds the given speed previously specified according to the road class (Step A4: NO), the control device 11 retrieves road traffic information received by the VICS receiver 9 (Step A5). The control device 11 then determines whether the current position is included in congested points or congested sections of the received road traffic information (Step A6). When the current position is included in the congested points or congested sections of the received road traffic information (Step A6: YES), the control device 11 returns the sequence without computing an average vehicle speed. Thus, when the vehicle stops (or runs at 40 km/h or less in an expressway) or encounters the congestion, the control device 11 functions as an computation controlling unit to stop computation of an average vehicle speed.

When the current position is not included in congestion points or sections of the received road traffic information (Step A6: NO), the control device 11 repeatedly executes Steps A2 to A6 until the vehicle travels one kilometer of the determination distance. When the vehicle has traveled one kilometer (Step A7: YES), the control device 11 divides the determination distance by a time period required for traveling the determination distance so as to compute an instantaneous vehicle speed (Step A8).

Next, the control device 11 determines a road class of an on-travel road the vehicle is currently traveling (Step A9), and computes an average vehicle speed V under Formula (1) using the previously computed average vehicle speed V′. Here, there may be a case where the present time computation of the average vehicle speed is the first computation after the vehicle starts from the starting point of the road class the vehicle is presently traveling. In this case, a previous time (or previously computed) average vehicle speed V′ is not stored in the RAM as a primary storing unit of the control device 11. Therefore, an initial average vehicle speed according to the road class is used as the previous time average vehicle speed V′ for computing an average vehicle speed V. Namely, when the on-travel road belongs to the first class, 30 km/h is used for V′ (Step A10); when the on-travel road belongs to the second class, 40 km/h is used for V′ (Step A11); and when the on-travel road belongs to the third class, 90 km/h is used for V′ (Step A12). The control device 11 then ends the routine shown in FIG. 2 and returns the sequence.

After computation of the average vehicle speed is completed, the routine in FIG. 3 starts. The control device 11 subtracts a distance the vehicle has traveled from a whole route distance of the route to compute a remaining distance to the destination (Step S1: YES, and then Step S2). Then an estimated remaining necessary time is computed using the average vehicle speed computed in the routine of FIG. 2 (Step S3). This computation of the estimated remaining necessary time will be explained below in detail.

Namely, the control device 11 detects a current position from detection data by the position detector 2 and thereby recognizes road classes of the remaining travel route, remaining distances relative to the individual road classes. With respect to the same road class as a given road class of the on-travel road, the remaining distance of the given road class is divided by the average vehicle speed V computed in the routine of FIG. 2 to compute a remaining necessary time of the road of the given road class. With respect to each of road classes other than the given road class, the corresponding remaining distance is divided by the initial average vehicle speed according to a road class in FIG. 4 to compute a necessary time to the road of the each road class. The necessary time relative to the given road class and the necessary times relative to the road classes other than the given road class are added up to obtain an estimated remaining necessary time. Furthermore, there may be a case where the on-travel road of the given road class is connected to one or more different road classes and then a certain road of the given road class is connected to the one or more different road classes. In this case, in computation of an average vehicle speed relative to the certain road, an initial average speed can be used instead of the average vehicle speed V computed in the on-travel road of the given road class.

Then, the control device 11 retrieves a current time instant and adds the estimated necessary time to the current time instant to compute an estimated arrival time (Step S4). Thereafter, the control device 11 causes the display device 6 as a notifying unit to display the estimated remaining necessary time and the estimated arrival time (Step S5).

The control device 11 then executes the routine in FIG. 2 to compute an average vehicle speed, and further compute a remaining necessary time and an estimated arrival time in the routine in FIG. 3 using this average vehicle speed. The remaining necessary time and the estimated arrival time are displayed on the display device 6. The foregoing process is repeatedly executed. Here, when the vehicle enters a road of a different road class and the control device 11 then executes the first computation of an average vehicle speed in the entered road, an initial average vehicle speed in FIG. 4 is substituted for the previous time average vehicle speed V′.

In this embodiment, when the vehicle is in a congestion point or section, an average vehicle speed is not computed. Namely, there may be a case where a vehicle does not stop but travels at a low vehicle speed slower than usual. In this case, a resultant average vehicle speed may become very slow. In this embodiment, this very slow speed is prevented from being reflected on computation of an average vehicle speed. Therefore, this embodiment can effectively solve the following conventional problem: a computed average vehicle speed is much decreased due to an influence of a low instantaneous vehicle speed caused in a congested road; thereby, an estimated necessary travel time to a destination is significantly deviated from a proper time.

### Second Embodiment

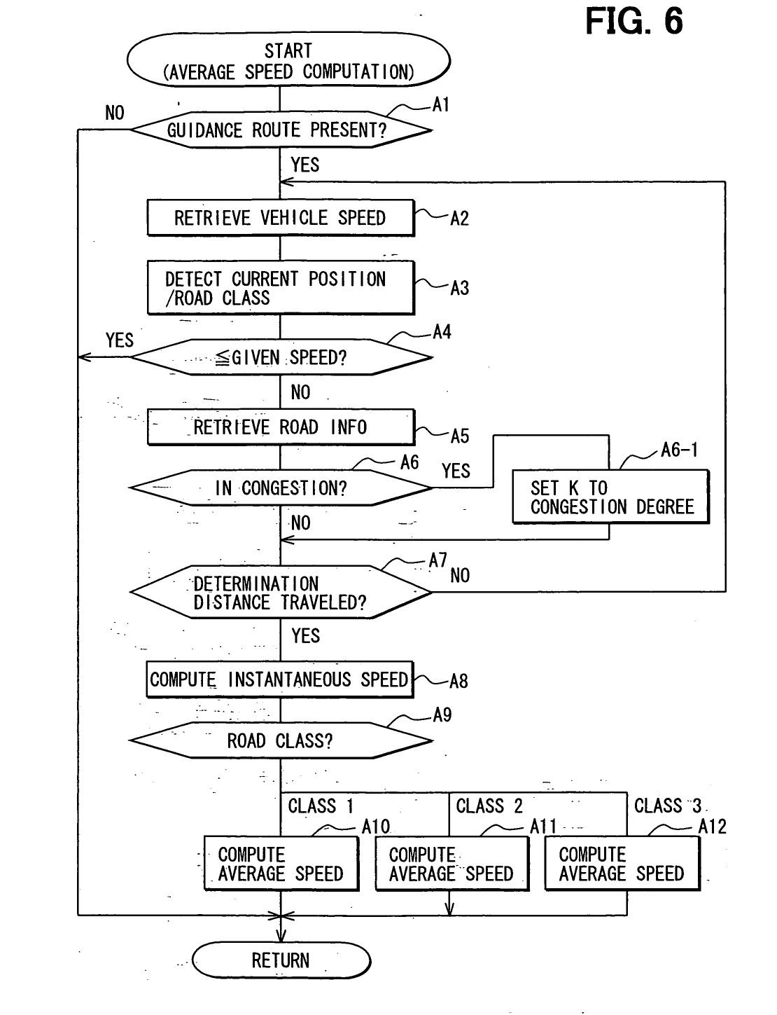

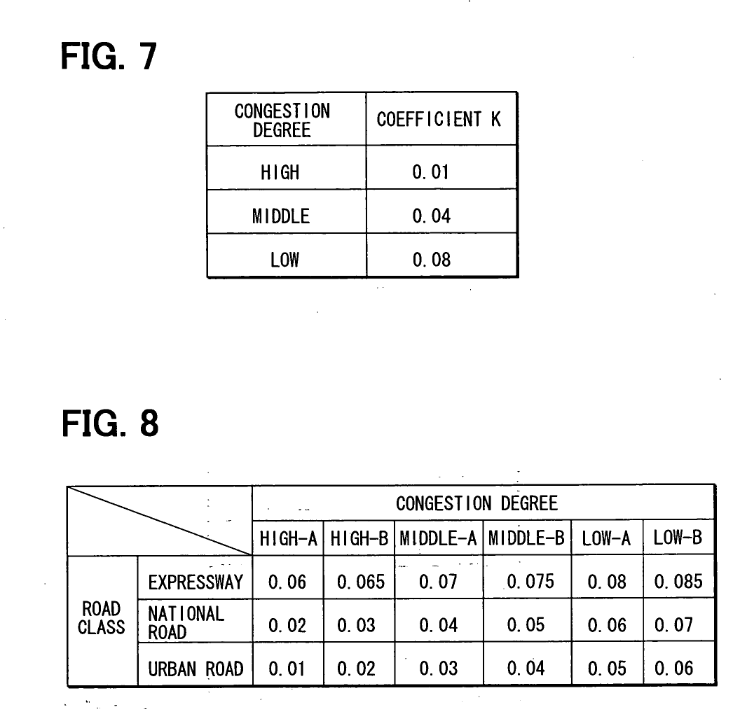

A second embodiment will be explained below with reference to FIGS. 6, 7. The second embodiment is different from the first embodiment with respect to the following: in a congested state, computation of an average vehicle speed is not stopped but is executed with coefficient K in Formula (1) varied based on a congestion degree.

In the first embodiment, an average vehicle speed is computed with an instantaneous vehicle speed Va in Formula (1), and a weight or ratio of the instantaneous Va is reflected by multiplying a difference from a previous time average vehicle speed V′ by a coefficient K. This coefficient K specifies the weight of the instantaneous Va in the computation of the average vehicle speed, and is set to 0.1 regardless of congestion degrees in the first embodiment.

In contrast, in the second embodiment, as shown in FIG. 7, degrees of congestion are classified into three levels of “HIGH,” “MIDDLE,” and “LOW.” The coefficient K is 0.01 in “HIGH”; 0.04 in “MIDDLE”; and 0.08 in “LOW.” The degrees of congestion can be determined based on a distance of congestion or a vehicle speed in the congestion. The coefficients K according to the degrees of congestion are stored in a CD-ROM or a DVD-ROM for storing the map data.

In the routine of computing an average vehicle speed in FIG. 6, when the vehicle's current position is included in congestion points or sections of the road traffic information (Step A6: YES), the control device 11 as the computation controlling unit detects a congestion degree from the road traffic information and designates a coefficient K meeting the corresponding congestion degree (Step A6-1). The control device 11 then computes an instantaneous vehicle speed when the vehicle has traveled the determination distance. At the first computation of an average vehicle speed, an average vehicle speed V is computed using an initial average vehicle speed based on a road class of the on-travel road and a coefficient K based on the relevant congestion degree. At the second and subsequent computation, an average vehicle speed V is computed using the previous time average vehicle speed V′ and a coefficient K based on the relevant congestion degree.

Thus, in the second embodiment, a coefficient K is varied based on a congestion degree to vary a weight or ratio of an instantaneous vehicle speed. As long as the vehicle does not stop, an instantaneous vehicle speed can be used for computing an average vehicle speed without significantly decreasing an average vehicle speed. Therefore, even when the vehicle travels at a slow speed, the resultant decrease of the average vehicle speed can be reflected on the estimated necessary time.

### Third Embodiment

A third embodiment will be explained below with reference to FIG. 8. The third embodiment is different from the second embodiment in the following: a weight of an instantaneous vehicle speed is varied based on not only a congestion degree but also a road class. Namely, as shown in FIG. 8, a coefficient K is differentiated based on congestion degrees and road classes. These coefficients K are stored in a storing unit such as a CD-ROM or a DVD-ROM.

In this embodiment, in congestion, an instantaneous vehicle speed is weighted in correspondence to a road class and then is used for computing an average vehicle speed. For instance, a vehicle speed in a similar congestion degree is differentiated between an expressway and an urban road. Namely, in the congestion, a vehicle may travel an expressway at 30, 50, or 70 km/h, whereas a vehicle may travel an urban road at no more than 5 or 10 km/h. That is, a vehicle speed in congestion is different between an expressway and an urban road. In this case, a weight for using an instantaneous vehicle speed is varied based on a road class and a congestion degree; thereby, an actual traveling speed can be reflected on an average vehicle speed according to a road class and a congestion degree. Consequently, an estimated necessary time and an estimated arrival time can be computed to meet actual conditions.

(Modification)

An estimated necessary time and an estimated arrival time can be outputted through the speaker 12 as a notifying unit.

The road traffic information can be obtained from a radio tuner.

Computation of an average vehicle speed can be obtained using another formula instead of Formula (1).

An instantaneous vehicle speed is obtained by dividing a given distance by a time period required for traveling the given distance can be differently obtained. Namely, an instantaneous vehicle speed can be obtained by averaging vehicle speeds obtained with given intervals.

Steps in the flowcharts may be constructed as means or units in program stored in the ROM or the like.

It will be obvious to those skilled in the art that various changes may be made in the above-described embodiments of the present invention. However, the scope of the present invention should be determined by the following claims.

What is claimed is:

1. An average vehicle speed computation device for computing an average speed of a vehicle, the device comprising:
a current position obtaining unit for obtaining a current position of the vehicle;
a road traffic information obtaining unit for obtaining road traffic information including at least a congested point or a congested section; and
a computation controlling unit for stopping computation of the average speed when the obtained current position is included within the congested point or the congested section which is obtained by the road traffic information obtaining unit.

2. The average vehicle speed computation device of claim 1, further comprising:
a speed detecting unit for detecting a speed of the vehicle,
wherein when the detected speed is equal to or less than a given speed, the computation of the average speed is stopped.

3. An average vehicle speed computation device for computing an average speed of a vehicle using an instantaneous speed, wherein the instantaneous speed is obtained as an average speed with respect to a determination distance each time the vehicle travels the determination distance,
the device comprising:
a current position obtaining unit for obtaining a current position of the vehicle;
a road traffic information obtaining unit for obtaining road traffic information including at least a congested point or a congested section; and
a computation controlling unit for designating a weight of the instantaneous speed in computation of the average speed based on a congestion degree, when the obtained current position is included within the congested point or the congested section which is obtained by the road traffic information obtaining unit,
wherein, when the obtained current position is included within the the congested point or the congested section, a degree for using the instantaneous speed in the computation of the average speed is varied based on the weight designated by the computation controlling unit.

4. The average vehicle speed computation device of claim 1, further comprising:
a road class detecting unit for detecting from the current position a road class of a road the vehicle is traveling,
wherein the computation controlling unit designates the weight of the instantaneous speed based on the road class in addition to the congestion degree.

5. The average vehicle speed computation device of claim 3, further comprising:
a speed detecting unit for detecting a speed of the vehicle,
wherein when the detected speed is equal to or less than a given speed, the computation of the average speed is stopped.

6. Car navigation device including a route retrieval function and a route guidance function, the car navigation device comprising:
the average vehicle speed computation device of claim 1;
a remaining distance computing unit for computing a remaining distance from a current position to a destination during route guidance;
a necessary time computing unit for computing an estimated necessary time to a destination based on the computed remaining distance and the average speed computed by the average vehicle speed computation device; and
a notifying unit for indicating at least one of (i) the computed estimated necessary time and an estimated arrival time to the destination obtained from the computed estimated necessary time.

7. Car navigation device including a route retrieval function and a route guidance function, the car navigation device comprising:
the average vehicle speed computation device of claim 2;
a remaining distance computing unit for computing a remaining distance from a current position to a destination during route guidance;
a necessary time computing unit for computing an estimated necessary time to a destination based on the computed remaining distance and the average speed computed by the average vehicle speed computation device; and
a notifying unit for indicating at least one of (i) the computed estimated necessary time and an estimated arrival time to the destination obtained from the computed estimated necessary time.
